(19) United States
(12) Patent Application Publication
(10) Pub. No.: US 2026/0085006 A1
(43) Pub. Date: Mar. 26, 2026

(54) ARAGONITE AS A RHEOLOGY MODIFIER FOR BUILDING MATERIALS

(71) Applicant: The Trustees of Columbia University in the City of New York, New York, NY (US)

(72) Inventors: Diandian Zhao, New York, NY (US); Shiho Kawashima, Brooklyn, NY (US); Ah-Hyung Park, New York, NY (US); Jonah Williams, New York, NY (US)

(21) Appl. No.: 19/404,090

(22) Filed: Dec. 1, 2025

Related U.S. Application Data
(63) Continuation of application No. PCT/US2024/032143, filed on May 31, 2024.
(60) Provisional application No. 63/505,953, filed on Jun. 2, 2023.

(51) Int. Cl. C04B 22/10; C04B 14/10; C04B 16/04; C04B 28/04; C04B 28/14; C04B 103/00

(52) U.S. Cl. CPC C04B 22/10; C04B 14/10; C04B 16/04; C04B 28/04; C04B 28/14; C04B 2103/0079

(57) ABSTRACT

Provided is a building material, comprising: a base material and an amount of aragonite, the aragonite optionally present at up to about 60 wt % of the total weight of the base material and the aragonite. The base material can include any one or more of a cementitious material, a clay, a biopolymer, gypsum, and lime. The disclosed materials are useful in manufacturing processes, including additive manufacturing and other construction processes.

### RELATED APPLICATIONS

The present application is a continuation of International Patent Application No. PCT/US2024/032143 (filed May 31, 2024), which claims priority to and the benefit of U.S. Patent Application No. 63/505,953, “Aragonite As A Rheology Modifier For 3D Printing Of Concrete Or Ceramics” (filed Jun. 2, 2023). All foregoing applications are incorporated herein by reference in their entireties for any and all purposes.

### TECHNICAL FIELD

The present disclosure relates to the field of building materials.

### BACKGROUND

Limestone has been used in the cement industry for many decades. It can be used as a cement substitute and has a so-called ‘filler effect’, which accelerates the hydration of cement by providing additional surface area for nucleation. Limestone mainly consists of calcite, and calcite-containing cements and other building materials exhibit deficiencies when used in certain manufacturing processes, in particular additive manufacturing processes. Accordingly, there is a long-felt need in the art for improved building materials, including improved cements, among others.

### SUMMARY

In meeting the described long-felt needs, the present disclosure provides a building material, comprising: a base material and an amount of aragonite, the aragonite optionally present at up to about 60 wt % of the total weight of the base material and the aragonite.

Also provided is a structural concrete, the structural concrete comprising an amount of a building material according to any one of Aspects 1-14, wherein the base material comprises a cementitious material.

Further provided is a method, comprising combining a base material and an amount of aragonite so as to give rise to a building material according to the present disclosure, for example according to any one of Aspects 1-18.

Also disclosed is a method, comprising dispensing an amount of a building material according to the present disclosure-such as any one of Aspects 1-18-in a manufacturing process.

Further provided is a structure, comprising: a structural element comprising a building material, the building material comprising a base material and an amount of aragonite, the aragonite optionally present at up to about 60 wt % of the total weight of the base material and the aragonite.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Oscillation amplitude sweep from 10⁻⁵ to 10⁻¹ to determine the linear viscoelastic region (LVR). The critical strain is determined as slightly higher than 10⁻⁴.

FIG. 2. Scanning electron micrographs of calcium carbonate (CaCO₃) polymorphs showcasing their distinct crystalline morphologies: (a) calcite (cubic), (b) aragonite (needle-like), and (c) vaterite.

FIG. 3. Particle size analysis of OPC and the synthetically produced calcium carbonate polymorphs, calcite, aragonite, and vaterite. (a) Distributive particle size; (b) Cumulative particle size distribution.

FIG. 4. (a) Nitrogen adsorption isotherms and (b) BET surface area of OPC and the produced calcium carbonate polymorphs, calcite, aragonite, and vaterite.

FIG. 5. XRD patterns and quantification of calcium carbonate polymorphs through Rietveld refinement.

FIG. 6. (a) Weight loss curves and (b) derivative weight loss curves of calcium carbonate polymorphs between 25° C. to 1000° C. obtained by TGA.

FIG. 7. (a) Viscosity of cement pastes made with calcium carbonate polymorphs during pre-shear (color dots: raw data; lines: fitted models; shades: standard deviation), and (b) dynamic viscosity obtained as the values when the curves reach steady state.

FIG. 8. (a) Stress versus time curves of cement pastes with calcium carbonate polymorphs obtained via rotational tests at 0.1 s⁻¹ shear rate after a resting time of 30 s. (b) Rescaled plot showing only the stress-time curves of OPC, Calcite20 and Vaterite20 for better comparison. The shaded areas indicate the standard deviation of each curve.

FIG. 9. (a) Static yield stress evolution of cement pastes made with calcium carbonate polymorphs over time (color dots: raw data, lines: fitted models, error bars: standard deviation). (b) Rescaled plot showing only the static yield stress evolution of OPC, Calcite20 and Vaterite20 for better comparison.

FIG. 10. (a) Dynamic yield stress evolution of cement pastes made with calcium carbonate polymorphs over time (color dots: raw data, lines: fitted models, error bars: standard deviation). (b) Rescaled plot showing only the dynamic yield stress evolution of OPC, Calcite20 and Vaterite20 for better comparison.

FIG. 11. Thixotropy index evolution of cement pastes incorporating calcium carbonate polymorphs over time.

FIG. 12. Small amplitude oscillatory shear (SAOS) at 10⁻⁴ to monitor the structural build-up of cement paste through storage modulus evolution (color dots: raw data, lines: fitted models).

FIG. 13. Static yield stress of cement-water systems versus cement-kerosene systems to isolate the geometry effects of various polymorphs on rheological properties of cement pastes.

FIG. 14. Schematic illustration of how the shapes of different calcium carbonate polymorphs, (a) calcite, (b) aragonite, and (c) vaterite, interrupt and deflect the flow lines of the liquid flowing around them. (d) Needle-like aragonite crystals can adapt their orientation along the shearing direction, resulting in high thixotropy behavior, i.e. high static yield stress and low dynamic yield stress.

FIG. 15. Heat flow of cement pastes with calcium carbonate polymorphs normalized based on per gram of cement to identify any effects the polymorphs may have on the hydration kinetics of cement. (a) Heat flow up to ˜168 hours (7 days) showing the main hydration peaks and the time window for rheological tests. (b) Rescaled plot showing only the early heat flow during the time window for rheological tests for better visualization.

FIG. 16. Cumulative heat release of cement pastes with calcium carbonate polymorphs normalized based on per gram of solid, indicating the absolute amount of hydrated phase produced. (a) Cumulative heat releases up to ˜168 hours (7 days) showing the main hydration peaks and the time window for rheological tests. (b) Rescaled plot showing only the early cumulative heat releases during the time window for rheological tests for better visualization.

FIG. 17. Zeta potential of calcium carbonate polymorphs dispersed in deionized water (pH=7).

FIG. 18. Example structures printed with 3D printed cement pastes having two loading levels of aragonite (10 wt % and 20 wt %, Ara10 and Ara20, respectively) at three water/solid (w/s) ratios (0.35, 0.40, and 0.45). The numbers indicate the solid volume fraction of the pastes. For the control samples with only ordinary Portland cement (OPC), the samples did not sustain their own weight upon printing and show different degrees of deformation. As seen, the higher the water content, the larger the deformation. The incorporation of aragonite increases the yield stress of the cement pastes and improves their printability. Even at comparatively higher w/s ratios like 0.45, cement pastes with 10 wt % or 20 wt % can be successfully printed.

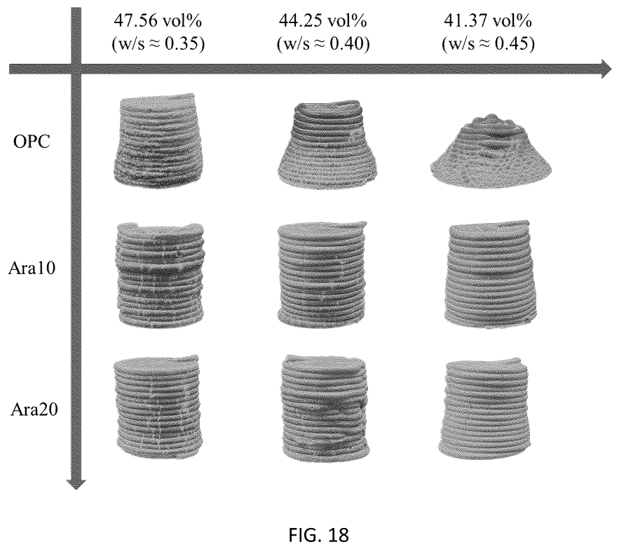

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated+10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments of aspects can be combined with any part or parts of any one or more other embodiments or aspects.

The disclosed technology provides, for example, building materials and related methods. Although certain description included herein relates to cementitious building materials, it should be understood that such description is exemplary only and that the disclosed technology is not limited to cementitious materials or the materials described in the examples herein.

Naturally occurring limestone currently used for concrete production mainly consists of calcite, and the other two metastable forms of anhydrous calcium carbonate include aragonite and vaterite. All three calcium carbonate polymorphs were synthesized at laboratory conditions and their effects on cement rheology were investigated. After comprehensive characterization of the polymorphs, they were used as cement substitutions (20 wt. %) to prepare pastes for rheological testing. Aragonite was found to increase the initial static yield stress, dynamic yield stress, and storage modulus of cement pastes, while calcite and vaterite did not. The rate of structural build-up was also enhanced by aragonite, as indicated by higher rates of static yield stress development and storage modulus increase over time. The underlying mechanisms of the rheological changes induced by the calcium carbonate polymorphs-geometric features, hydration kinetics, and surface charge-were considered and supported with experimental evidence.

Limestone has been used in the cement industry for many decades. It can be used as a cement substitute and has a so-called ‘filler effect’, which accelerates the hydration of cement by providing additional surface area for nucleation. Limestone mainly consists of calcite, which is one of the three anhydrous polymorphs of calcium carbonate. The other two metastable forms of anhydrous calcium carbonate include aragonite and vaterite, which tend to transform to calcite under certain conditions.

Calcite is the most common and thermodynamically stable calcium carbonate polymorph that can be found in nature. Aragonite is less stable but can be naturally occurring in locations such as springs or biologically formed in shells and corals. Vaterite is the least stable polymorph and can easily transform to calcite, which makes it less commonly deposited in nature. As naturally occurring aragonite and vaterite do not deposit at large scales, their industrial uses are quite limited, especially for construction purposes. However, these two metastable polymorphs can be artificially synthesized through the control of pH, temperature, reaction time, ion stoichiometry or with the help of additives that can act as stabilizers.

The most common method to produce calcium carbonate synthetically is through a dissolution-precipitation process, during which sources of calcium and carbonate are dissolved in water. Once the solution reaches saturation with respect to calcium carbonate, precipitation will occur. The precipitation process starts from amorphous calcium carbonate, and then quickly transforms into vaterite, a metastable calcium carbonate polymorph. After that, the metastable vaterite phase will continue to convert to the more stable form, calcite, within a very short period time through dissolution and recrystallization. The vaterite can also transform to aragonite if crystallization is performed at higher temperature (>60° C.). By understanding this mechanism, one can produce different polymorphs through manipulating the experimental factors of this process. For example, to obtain vaterite, additives can be used to interrupt the transformation of vaterite to calcite. Additives that have been found to be effective are magnesium, sulfate, phosphate, ammonium or organic polymers such as polyacrylic acid (PAA), phthalic acid, and the like.

To form aragonite, temperature control can be used to guide the converting direction of vaterite to avoid the formation of calcite. It can also be achieved through a seeding approach, by which aragonite crystals are introduced as nucleation seeds. To lower the CO₂ emissions during the production process, waste calcium sources such as waste concrete, slag, and fly ash can be utilized, together with carbon sources like exhausted CO₂ from industrial activities to achieve carbon utilization.

The rheological properties of natural limestone powder, mainly calcite, has been extensively studied in the literature. Due to the cubic shape of calcite, it does not induce significant changes to the rheology of cement paste when its particle size is similar to that of cement. If the particle size of calcite is much larger than that of cement, it may improve the workability of cement paste, or vice versa.

As described herein, calcite, aragonite and vaterite were synthetically crystallized under laboratory conditions. After synthesis, these three polymorphs were characterized comprehensively to determine their morphologies, particle size distribution, specific surface area and phase composition. The polymorphs were then used as cement substitutions to replace 20 wt. % of Portland cement. The rheological properties, including dynamic viscosity, static and dynamic yield stress development, and storage modulus evolution were measured and investigated comprehensively. The underlying mechanisms of how these polymorphs modify the rheological properties of cement pastes were discussed and supported with experimental evidence: geometric features, hydration kinetics, and surface charge.

### Materials and Methods

### Synthesis of Calcium Carbonate Polymorphs

The synthesis protocol for the calcium carbonate polymorphs was based on both empirical laboratory observations and available literature. In order to produce enough materials for the purposes of the rheological testing, 200-gram synthesis batches were conducted in 4-L ChemGlass beakers. For each reaction, 221 g of CaCl₂) (Sigma-Aldrich, >93% purity, anhydrous) were dissolved in 2 L of Millipore DI water (1 M solution). For the synthesis of calcite, 276 g of K₂CO₃ (Alfa Aesar, 99% purity, anhydrous) were dissolved in 2 L of Millipore DI water as well. The calcium and carbonate solutions were rapidly mixed and stirred at room temperature (600 RPM) for 24 hours (final Ca²⁺:CO₃²⁻ molar ratio of 1:1).

For the synthesis of aragonite, the same stock concentrations of CaCl₂) and K₂CO₃ were prepared and heated to 80° C. for 1 hour prior to rapid mixing. Previous studies have shown that aragonite can be produced in laboratory conditions at elevated temperatures. After mixing, the reaction vessel temperature was maintained at 80° C. for 20 minutes under rapid stirring (600 RPM), and then was immediately filtered. For the synthesis of vaterite, previous studies utilizing additive salts (such as ammonia, sulfate, and phosphate) guided the ideal stoichiometry for this crystallization. 221 g of CaCl₂) was prepared in 2 L of Millipore DI water with 106 g of NH₄Cl (Sigma-Aldrich, 99% pure). 552 g of K₂CO₃ were prepared in 2 L of Millipore DI water. The reactant mixtures were rapidly mixed and stirred at room temperature for 10 minutes before filtration began in a chemical fume hood due to ammonia degassing. The final ideal vaterite molar stoichiometry was 1 Ca²⁺: 1 NH₄⁺: 2 CO₃²⁻. All reaction mixtures were filtered using a classical Buchner funnel vacuum apparatus. The precipitated calcium carbonate (PCC) was washed with 190 proof ethanol prior to drying in a vacuum oven at 70° C. overnight.

### Materials and Specimen Preparation

The cement used in this study was Type I cement from Lehigh Hanson and its chemical composition is shown in Table 1. The specific gravity of cement and the synthetic calcium carbonate polymorphs are shown in Table 2. Distilled water was used to prepare all of the specimens and the water-to-solid (w/s) ratio was kept constant at 0.4. Calcite, aragonite and vaterite were used to replace cement at 20% by mass. Since the specific gravity of cement and calcium carbonate polymorphs are similar, all the mixtures had a similar solid volume fraction of ˜46%. For the mixing protocol, the dry materials were first mixed homogeneously before adding water. Then, distilled water was introduced, and the mixture was mixed at high speed for 2 minutes.

TABLE 1
Chemical composition of ordinary Portland cement.

| | Weight percentage |
|---|---|
| Oxide | (wt. %) |
| SiO₂ | 19.06 |
| Al₂O₃ | 5.01 |
| Fe₂O₃ | 2.27 |
| CaO | 62.55 |
| MgO | 2.93 |
| SO₃ | 3.31 |
| Na₂O | 0.30 |
| K₂O | 1.04 |
| LOI* | 2.84 |

*LOI: Loss on Ignition

TABLE 2
Specific gravity of cement and synthetic
calcium carbonate polymorphs.

| | Specific gravity |
|---|---|
| Materials | (g/cm³) |
| Cement | 3.02 ± 0.07 |
| Calcite | 2.58 ± 0.11 |
| Aragonite | 2.59 ± 0.09 |
| Vaterite | 2.54 ± 0.16 |

### Analytical Methods

Scanning electron microscopy (SEM) was used to characterize the morphologies of calcium carbonate polymorphs and the distinct nature of their crystal habits. The measurements were performed on a Zeiss Sigma VP SEM under secondary electron mode at a voltage of 3 kV. The calcium carbonate powders were sprayed onto a piece of carbon tape and AuPd coating was applied to improve the conductivity of the materials and enhance image quality.

A LS 13 320 Beckman Coulter laser diffractometry (LD) instrument was utilized to analyze the produced polymorphs of calcium carbonate to determine their particle size distribution (PSD). Approximately 50-100 mg of sample was injected into a mixed water column that was circulated through an ebullating pump. The samples were analyzed for 30 seconds using three different optical filters and 80 vol. % ethanol was used as a dispersant in some cases of analysis.

Braunauer-Emmett-Teller (BET) surface area analysis was conducted using a Quantachrome NoveE BET Analyzer. This was done to establish the relative surface areas of the calcite, vaterite, and aragonite polymorphs of calcium carbonate in m²/g. The samples were vacuum degassed at 80° C. for six hours before measuring. Measurements were conducted at liquid N₂ temperatures after thermal equilibration for about 750 seconds and helium gas was used to backfill the vacuum flasks.

X-ray diffraction (XRD) coupled with Rietveld analysis was performed to determine the crystal structure of the calcium carbonates and their purities. The tests were conducted on a Panalytical Xpert3 Powder XRD at 45 kv and 40 mA with a PIXcel 1d detector. The tested range was 5°-70° 2θ. The step size was 0.013° and time per step was 60 s, resulting in a total scan time of ˜20 minutes. Rietveld analysis was performed with HighScore Plus software. The ICSD numbers of the structural data of the three polymorphs used for analysis were 73446 (Calcite), 170225 (Aragonite), and 15879 (Vaterite).

Rotational tests were conducted on a Thermo Scientific HAAKE MARS rheometer with a vane geometry to determine the rheological properties of cement pastes made with the three calcium carbonate polymorphs. The paste specimens were placed into the rheometer 10 minutes after mixing. A pre-shear of 220 s⁻¹ was applied to all the mixtures to ensure they all achieved the same reference state, during which dynamic viscosity evolution was measured as a response. A rest period with 0 Pa stress applied was included after the pre-shear.

Following the rest period, a constant applied shear rate of 0.1 s⁻¹ was applied to obtain a shear stress response, from which the static yield stress (maximum point indicating flow onset) and dynamic yield stress (equilibrium value) were determined. The development of yield stress over time was monitored by varying the rest time between the pre-shear and the rotational test. Three rest periods were tested: 0.5 minutes, 15 minutes and 30 minutes.

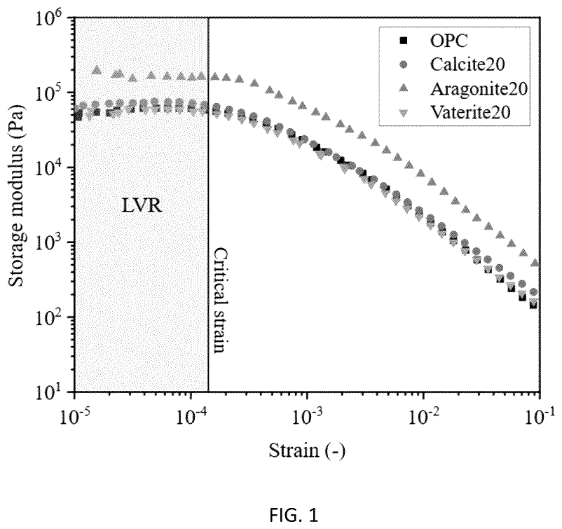

For each rotational test, at least three replicates were performed, and the average values were reported as the quantitative results. Small amplitude oscillatory shear (SAOS) tests were performed on a TA Discovery HR20 rheometer with a vane geometry to obtain measures of storage modulus evolution. A pre-shear of 220 s⁻¹ was applied before all the oscillation tests. Oscillatory amplitude sweep tests were first performed to obtain the linear viscoelastic region (LVR) of each mixture. A strain of 10⁻⁴ was selected based on the results of the amplitude sweeps (found to be within the LVR for all mixes, shown in FIG. 1) and a frequency of 1 Hz was selected to perform the SAOS tests.

Isothermal calorimetry was performed to determine the hydration kinetics of cement pastes. The calorimeter used was an 8-channel TAM Air from TA Instruments. Distilled water was used as a reference and the temperature was kept constant at 25° C. ˜ 5 grams of cement paste were used for each test. The tests were run for a total of 7 days or 168 hours.

Zeta potential was measured on a Malvern Zetasizer Nano ZS with folded capillary zeta cells (DTS1070) at 25° C. To prepare the samples, 10 mg of calcium carbonate was dispersed in 10 mL of distilled water and mixed homogeneously. The solution was then quickly transferred to the zeta cells for measurement. For each sample, three tests with 10 cycles per test were conducted and the average values were reported.

### Characterization Of Calcium Carbonate Polymorphs

### Morphology

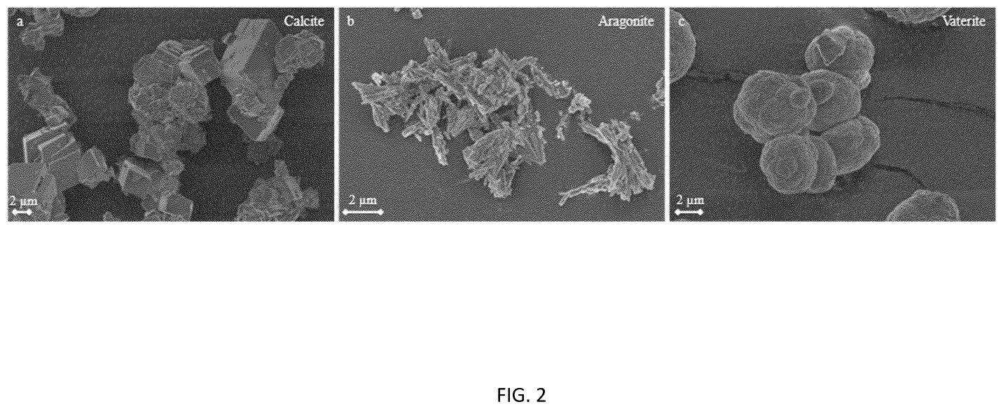

The morphology of the produced calcium carbonate polymorphs was studied using SEM. As observed in FIG. 2, each of the anhydrous polymorphs of calcium carbonate has a distinct crystal habit, making them easily identifiable from one another. Calcite is classically observed as single or multi-cubed clusters, based on its synthesis conditions. Synthetic aragonite usually exists as distinct needle structures, or “firecrackers”. The average length measured was ˜5.73±1.1 μm while the width was ˜0.94±0.2 μm, giving an aspect ratio of ˜6.37±2.0. Vaterite's most classic form is spherical, visually looking like clouds.

### Particle Size Distribution and Specific Surface Area

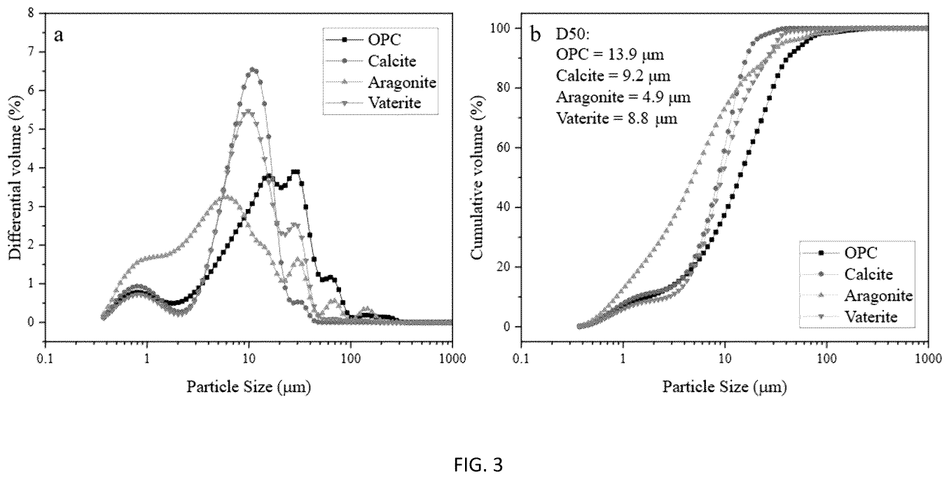

The particle size distribution of OPC and the synthetic calcium carbonate polymorphs is shown in FIG. 3. Calcite and vaterite exhibited similar volume % frequencies of particle sizes, with D50 of ˜9.2 and 8.8 μm, respectively, slightly lower than that of OPC, whereas aragonite had a much greater percentage of lower diameter sized particles (e.g., broad curve vs. sharper peaks) with D50 of ˜4.9 μm. The smaller peaks at >50 microns are likely artifacts of clumping during PSD analysis, despite the use of a dispersant (80 vol. %, EtOH).

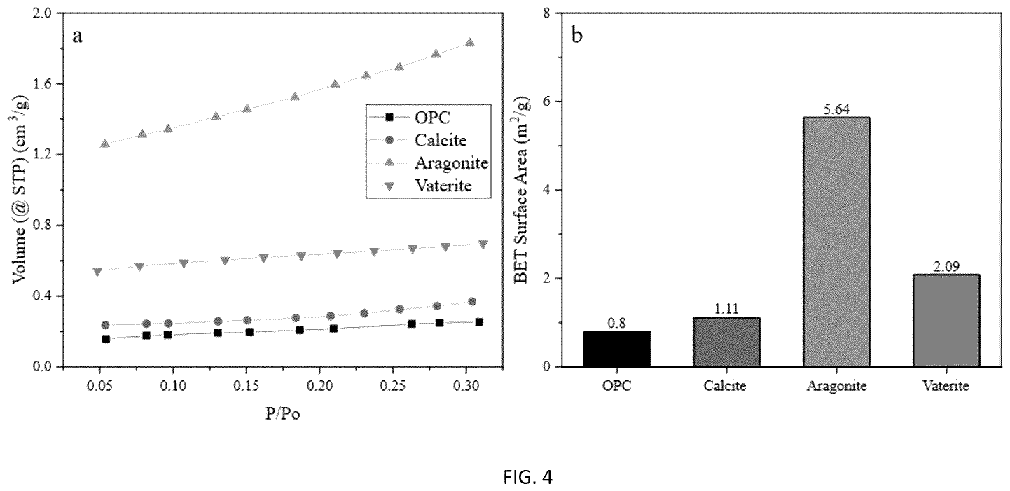

Nitrogen adsorption was utilized to establish the BET surface area of OPC and the produced calcium carbonate polymorphs. The differences in the adsorption isotherms can be seen in FIG. 4 (a), which reflects different surface areas, particularly aragonite. As shown in FIG. 4 (b), aragonite has a higher BET surface area of approximately 5.64 m²/g, compared to calcite (1.11 m²/g) and vaterite (2.09 m²/g). The needle-like shape of the aragonite crystals and high aspect ratio, as confirmed by SEM, are likely responsible for the difference in BET surface area.

### Phase Composition

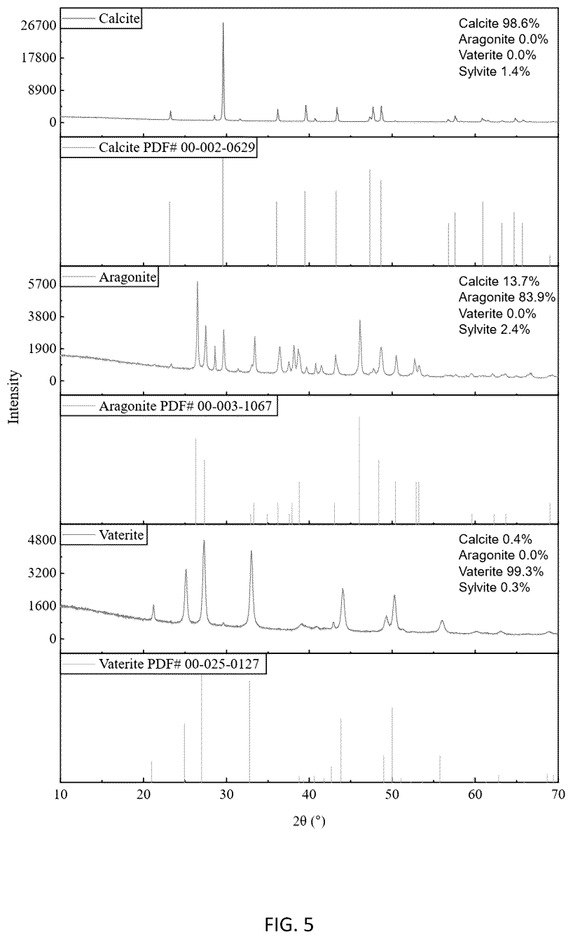

XRD and associated data refinement determined the % presence (by weight) of each polymorphic constituent in the batch production of calcite, vaterite, and aragonite, as shown in FIG. 5. To ensure relatively high purity of metastable aragonite and vaterite, they were produced in small batches (˜200 g each), and multiple batches were synthesized throughout this study. As calcite is the most thermodynamically stable form of calcium carbonate, its purity is usually >99 wt. %. On the other hand, metastable aragonite and vaterite tend to partially transform to calcite during synthesis. Their purities varied across different batches in the range of ˜85 wt. % to ˜ 99 wt. %.

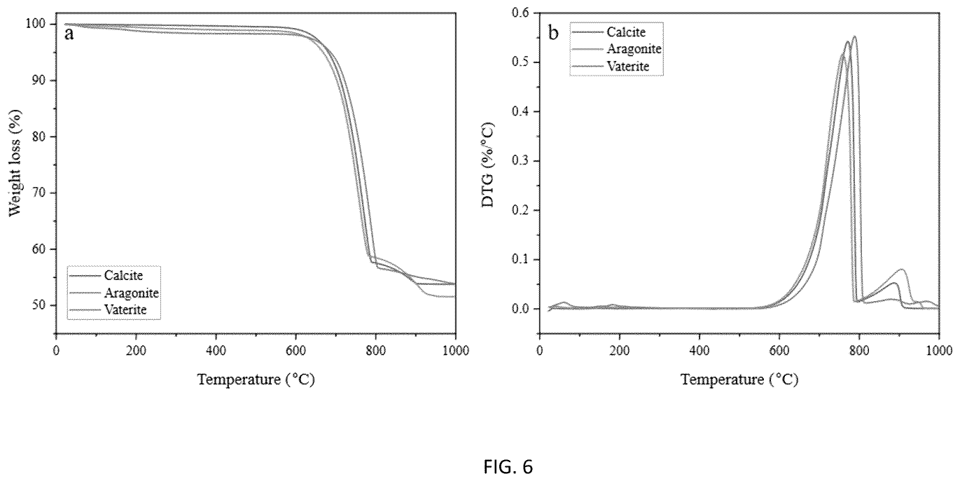

The weight loss curves, and derivative weight loss curves of the calcium carbonate polymorphs are shown in FIG. 6. It seems that the three polymorphs did not show significant differences in terms of thermal decomposition-they all decomposed at the temperature range of ˜600-800° C., during which CaCO₃ decomposed to form CaO and released CO₂ gas due to calcination.

### Dynamic Viscosity

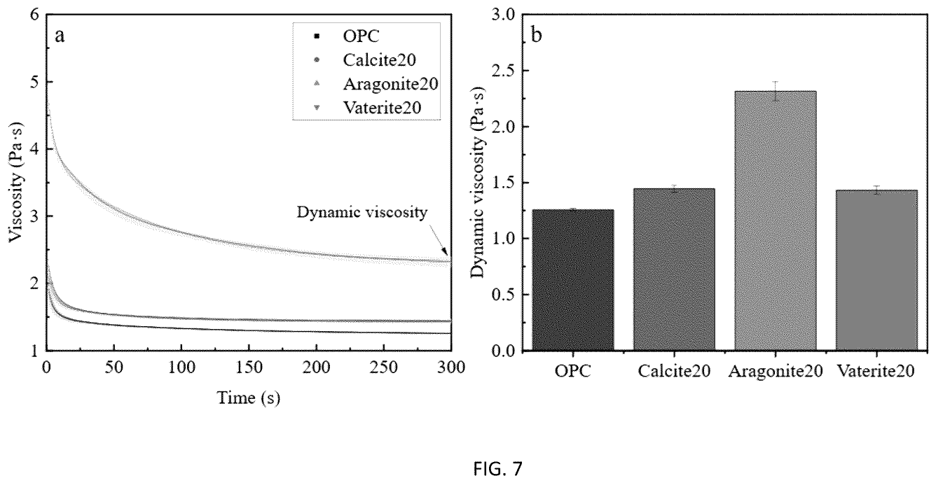

The viscosity of cement paste with calcium carbonate polymorphs during pre-shear is shown in FIG. 7 (a), and the dynamic viscosity obtained as the value at the end of the pre-shear tests is shown in FIG. 7 (b). All the pastes exhibited shear thinning behavior, but the degree of viscosity decay over time varied. Similar to the decay of stress during the shearing of shear-thinning fluids, the decay of viscosity of cementitious materials can be modeled by exponential decay models. One-phase (single) and two-phase (double) exponential decay are both used. The two-phase exponential decay function featured by two decay terms—a fast span and a slow span. For our data, the two-phase decay model was found to exhibit a better fit and was thus selected as the empirical model:

$$η = {η}_{0} + {a}_{1} {e}^{- t / t 1} + {a}_{2} {e}^{- t / t 2} \qquad ( 1 )$$

where η is the viscosity (Pa·s), t is the shearing time(s). η₀ is the dynamic viscosity (Pa·s) when the fluid reaches steady state. A₁, a₂ are amplitudes (Pa·s) of the exponential decay function—the higher the amplitude, the larger the range of decrease. T₁, t₂ are the time constants or characteristic time(s), and the shorter the characteristic time, the faster the rate of decay. The first decay term in our model was set as the fast decay term and the second term was set as the slow span term (t₁<t₂).

Table 3 shows the fitting results of the viscosity evolution using the two-phase exponential decay model. For the first term (fast span), the amplitude, a₁, of Aragonite20 is notably higher than those of the rest of the specimens, while the characteristic time, t₁, was similar for all specimens.

For the second term (slow span), the amplitude, a₂, of OPC, Calcite20 and Vaterite20 are nearly zero. As such, there is no significant contribution to the model by the second term for these three specimens. However, for Aragonite20, a₂ is 1.56, which indicates that the slow span still plays an important role in the viscosity decay caused by shear thinning. The differences in decay kinetics most likely originate from the distinct shapes of the calcium carbonate polymorphs. The cubic form of calcite and spherical form of vaterite are not significantly different from the shape of cement, which possesses irregular shapes that more or less resemble cubes or spheres. Therefore, they did not significant change the shear thinning behavior of cement pastes. On the other hand, it is clear that the Incorporation of aragonite crystals can alter the shear thinning behavior of cement pastes, leading to a higher amplitude of viscosity drop during shearing. This is most likely due to their unique needle-like shape, which enables them to flow along the shearing direction when subjected to prolonged shearing.

The dynamic viscosity, no, of Calcite20 and Vaterite20 were very similar and slightly higher than that of OPC, as shown in FIG. 7 (b), as well as indicated by the steady-state viscosity term no in Table 3. Aragonite20 has the highest dynamic viscosity, around two times larger than that of OPC. This is understandable as aragonite crystals synthesized in this study appeared to grow as crystal clusters, rather than dispersed single crystal (see FIG. 2). The applied shear condition was likely not sufficient to completely break down these clusters. Moreover, the growth of hydrated phases on the surface of these crystals through the ‘filler effect’ may further amplify the clustering phenomenon, which will be discussed in Section 3.5.2. As such, even though aragonite needles may be able to flow along the shearing direction, the three-dimensional network built by these clusters may not be completely broken down under these shear conditions, resulting in a dynamic viscosity that is still higher than the rest.

TABLE 3
Two phase exponential decay fitting
of viscosity data during pre-shear.

Model
η = η₀ + a₁ e^{-t/t1} + a₂ e^{-t/t2}

| Plot | OPC | Calcite20 | Aragonite20 | Vaterite20 |
|---|---|---|---|---|
| η₀ | 1.25 | 1.45 | 2.30 | 1.43 |
| a₁ | 0.58 | 0.57 | 1.16 | 0.76 |
| t₁ | 4.60 | 5.41 | 5.55 | 4.82 |
| a₂ | 0.23 | 0.21 | 1.56 | 0.27 |
| t₂ | 90.07 | 60.42 | 81.41 | 51.89 |
| R² | 0.9972 | 0.9986 | 0.9977 | 0.9977 |

### 3.3. Yield Stress Development

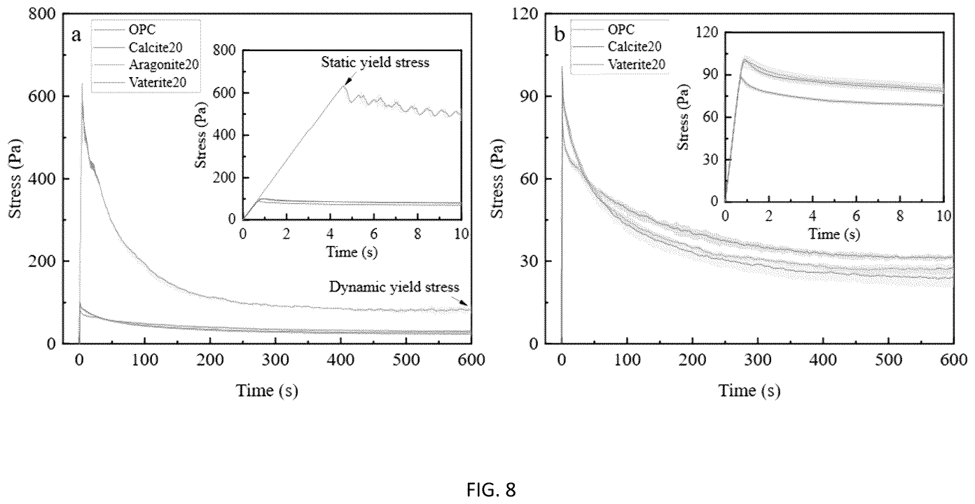

The development of yield stress of cement pastes over time was measured at 30 s, 900 s, and 1800 s after pre-shear. The stress versus time curves during the rotational tests at 0.1 s⁻¹ shear rate after a resting time of 30 s are shown as an example in FIG. 8 (a), and FIG. 8 (b) shows the rescaled plot for OPC, Calcite20 and Aragonite20 for better comparison. From FIG. 8 (a), it can be seen that Aragonite20 has a remarkably higher static yield stress than the rest of the samples. From FIG. 8 (b), Calcite20 and Vaterite20 have very similar static yield stress, which is slightly higher than that of OPC, but their dynamic yield stress is slightly lower than that of OPC. These differences, however, are not significant compared to the changes in Aragonite20. The development of static and dynamic yield stresses over time will be discussed in the following sections.

### Static Yield Stress

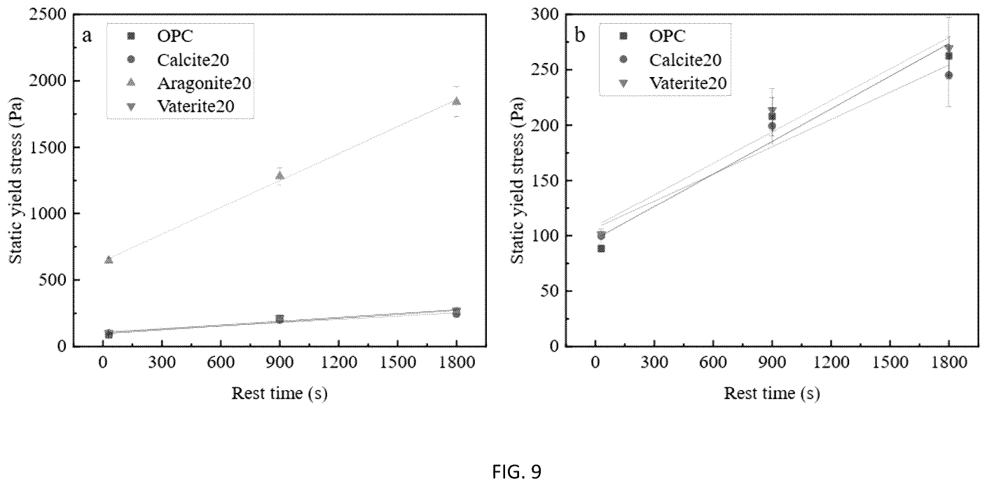

The development of static yield stress over time is shown in FIG. 9 (a), and the rescaled plot showing only OPC, Calcite20 and Vaterite20 is presented in FIG. 9 (b). The evolution of static yield stress over time is often fitted by a liner regression model:

$$τ = {τ}_{0} + {A}_{thix} t \qquad ( 2 )$$

where τ is static yield stress (Pa), tis time(s), τ₀ is the initial static yield stress (Pa) when t=0, Aₜₕᵢₓ is the structural build-up rate (Pa/s).

The fitting results using the linear regression model are shown in Table 4. The starting static yield stress, to, of Aragonite20 (˜650 Pa) was 6.5 times higher than that of Calcite20 and Vaterite20 (˜105 Pa), while the initial static yield stress of OPC was ˜100 Pa, slightly lower than that of Calcite20 and Vaterite20. With the development of time, there were no significant differences between the static yield stresses of OPC, Calcite20 and Vaterite20, and their structural build-up rates were very similar (Aₜₕᵢₓ=0.098, 0.082, 0.095, respectively). The static yield stress of Aragonite20, on the other hand, developed much faster than the rest of the specimens, with an Aₜₕᵢₓ of 0.676, ˜7 times higher than the rates of the rest of the specimens.

TABLE 4
Linear regression fitting of static yield stress over time.

Model
τ = τ₀ + Aₜₕᵢₓ t

| Plot | OPC | Calcite20 | Aragonite20 | Vaterite20 |
|---|---|---|---|---|
| τ₀ | 96.93 | 106.74 | 641.65 | 108.58 |
| Aₜₕᵢₓ | 0.098 | 0.082 | 0.676 | 0.095 |
| R² | 0.9514 | 0.9523 | 0.9977 | 0.9598 |

### Dynamic Yield Stress

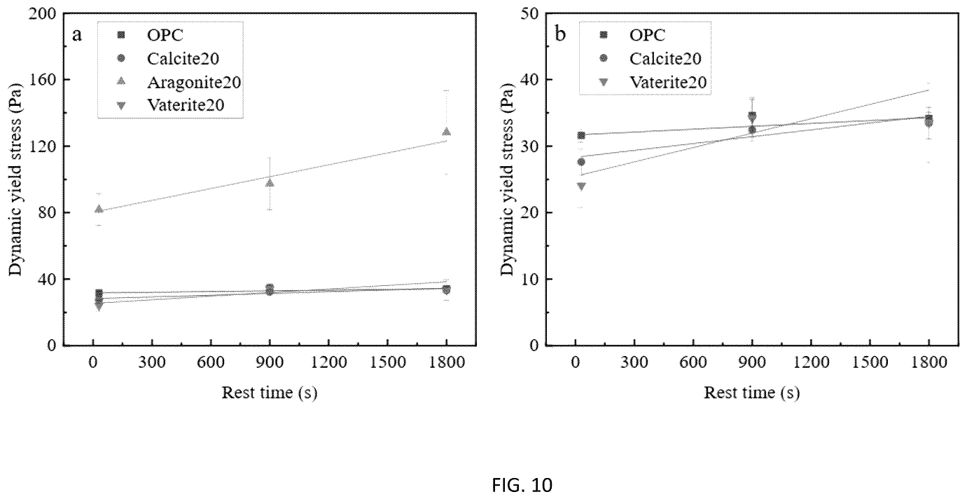

FIG. 10 shows the dynamic yield stress of cement pastes incorporating different calcium carbonate polymorphs. Similar to the static yield stress, the evolution of dynamic yield stress over time can also be modeled by the linear structural build-up model using Eq. (2). The fitting results are shown in Table 5.

The development of dynamic yield stress was much slower than the development of static yield stress, as indicated by Aₜₕᵢₓ values for dynamic yield stress in Table 5, which are an order of magnitude smaller than those in Table 4 for static yield stress. The dynamic yield stress can be considered to be constant during the test period for OPC, Calcite20 and Vaterite20 considering error, while Aragonite20 exhibited the highest initial dynamic yield stress, ˜2.8 times higher than the rest, and a measurable increase in dynamic yield stress over time (Aₜₕᵢₓ=0.02378). Similar to dynamic viscosity, the higher initial dynamic yield stress can be attributed to the aragonite crystal clusters, which cannot be completely broken down under the applied shear. The higher rate of development is likely due to the growth of hydrated phases on the surface of aragonite crystals, which, in turn, may also act as bridges between cement grains covered with hydrated phases.

TABLE 5
Linear regression fitting of dynamic yield stress over time.

Model
τ = τ₀ + Aₜₕᵢₓ t

| Plot | OPC | Calcite20 | Aragonite20 | Vaterite20 |
|---|---|---|---|---|
| τ₀ | 31.69 | 28.34 | 80.27 | 25.47 |
| Aₜₕᵢₓ | 0.00143 | 0.00343 | 0.02378 | 0.00721 |
| R² | 0.8889 | 0.8355 | 0.9628 | 0.7268 |

### Thixotropy Index

From the results of the static (FIG. 9) and dynamic (FIG. 10) yield stress, it can be seen that the influence of aragonite on static yield stress is more significant than its influence on dynamic yield stress. This discrepancy can be quantified through the thixotropy index, which is defined as the ratio between static yield stress and dynamic yield stress:

$${I}_{t h i x} = {τ}_{s} / {τ}_{d} \qquad ( 3 )$$

where Iₜₕᵢₓ is the thixotropy index, τₛ and τ_{d} are the static yield stress and dynamic yield stress (Pa), respectively, at a given shear rate and time.

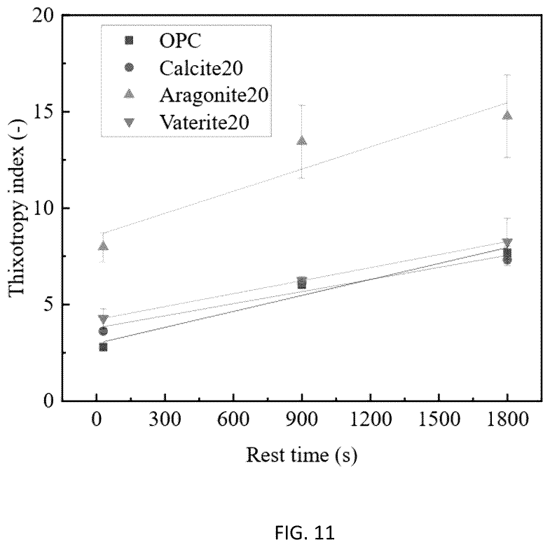

FIG. 11 shows the thixotropy index of the cement pastes with calcium carbonate polymorphs. The thixotropy index of all the specimens increased over time, and the rates of increase were quite similar. The thixotropy indices of OPC, Calcite20 and Vaterite20 were quite similar; however, Aragonite20 had a much higher thixotropy index at all testing periods, two times higher than the rest. Higher thixotropy index is beneficial for 3D printing, for instance, which requires high static yield stress and low dynamic yield stress.

### Storage Modulus Evolution

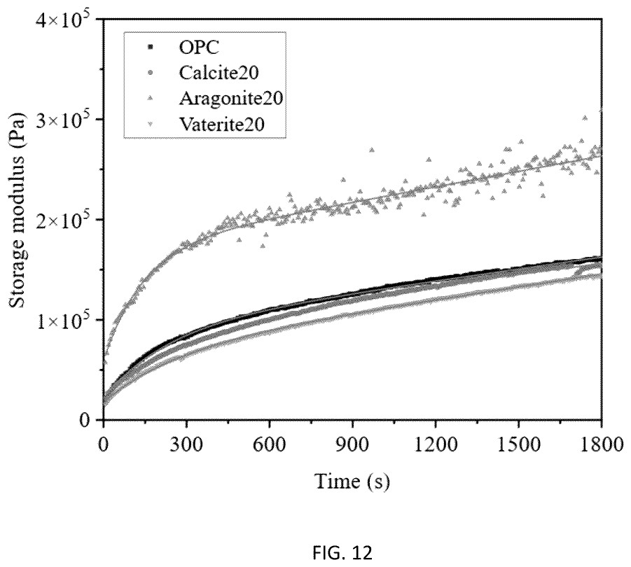

The storage modulus evolution of the samples were monitored over 30 minutes, and the results are shown in FIG. 12. These results can be modelled by a two-term structural build-up equation, in which the first term represents the recovery of flocculation/C-S-H network after pre-shear, while the second term represents the structural build-up of cement pastes due to hydration:

$${G}^{′} = c ( 1 + ( {λ}_{residual} - 1 ) {e}^{- t / θ} ) + {G}_{r i g i d} t \qquad ( 5 )$$

where G′ is the storage modulus (Pa), t is time(s), c is the amplitude of flocculation/C-S-H network recovery (Pa), λ_{residual} is the residual structural factor after pre-shear (0≤λ_{residual}≤1), θ is the characteristic time(s), and G_{rigid} is the rate of structural build-up due to hydration (Pa/s).

The fitted results are shown in Table 6. Aragonite20 exhibited the highest rate of recovery via flocculation after the imposed preshear, indicated by a higher amplitude, c, compared to those of OPC, Calcite20 and Vaterite20. Aragonite20 also exhibited a higher residual structure, λ_{residual}, immediately after preshear, in agreement with the results of viscosity, FIG. 7(a). Over time, the development of storage modulus of Aragonite20 was also higher than that of the other specimens, as indicated by G_{rigid}. These results are consistent with the static yield stress development shown in FIG. 9.

TABLE 6
Modelling of storage modulus evolution over time.

| | Model | | | |
|---|---|---|---|---|
| | G′ = c (1 + (λ_{residual} − 1) e^{-t/θ}) + G_{rigid} t | | | |
| Plot | OPC | Calcite20 | Aragonite20 | Vaterite20 |
| c | 91694.22 | 95487.33 | 171029.56 | 69326.41 |
| λ_{residual} | 0.2421 | 0.2719 | 0.3467 | 0.2628 |
| θ | 231.14 | 382.08 | 140.95 | 272.05 |
| G_{rigid} | 39.38 | 34.08 | 51.34 | 42.45 |
| R² | 0.9986 | 0.9972 | 0.9516 | 0.9993 |

### Mechanisms

From the results, it can be seen that the three calcium carbonate polymorphs affect the rheological properties of cement pastes differently. Aragonite can significantly increase the yield stress and storage modulus of cement pastes, while the other two polymorphs, calcite and vaterite, did not induce significant changes. Here, we try to probe the mechanisms of how these polymorphs affect the rheological properties of cement pastes, particularly aragonite. The mechanisms underlying these rheological modifications can be multifaceted and can be theorized as follows: 1) Geometric features—the differences in solid volume fraction, particle shape, and particle size distribution among the three polymorphs lead to different physical interactive forces that directly change the rheological properties; 2) Hydration kinetics—the polymorphs can affect the hydration kinetics of cement and induce changes in the volume of hydrated phases that can contribute to rigidification of the pastes; 3) Surface charge—the different surface charges of the polymorphs can cause different attracting/repulsive forces that may affect the rheology.

### Geometric Features

The physical factors that can influence the rheology of suspensions include solid volume fraction, particle shape, and particle size distribution. These factors affect the surface area of the particles, which in turn can change the physical forces, such as Van der Waals force, between particles. As cement paste is a complicated suspension system, to isolate the influence of various physical features of polymorphs on rheology from the chemically hydrating effect and surface charge due to ions present in the liquid phase, a non-hydrating system was used. Kerosene was used to replace water to prepare the cement pastes. Cement hydration cannot occur because of the lack of water, so there is no additional solid volume produced. In addition, since kerosene is a non-polar organic solvent, it does not disassociate or dissolve cement phases. The surface charging of the particles therefore is eliminated. The only difference among the various cement-polymorph-kerosene systems is the geometry effect.

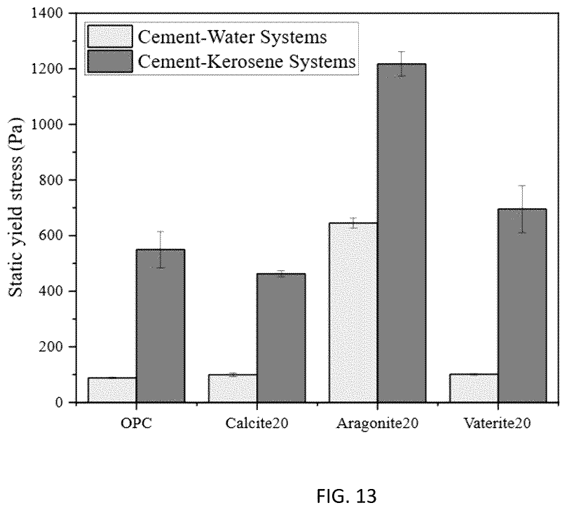

FIG. 13 shows the static yield stress of cement-water systems and cement-kerosene systems (resting time after pre-shear was 30 s). It can be seen that without any hydration and surface charge effects, the trend in the static yield stress among the cement-kerosene systems made with the three polymorphs is similar to that in the cement-water systems—Aragonite20 has the highest static yield stress while Calcite20 and Vaterite20 show similar static yield stress to OPC. These results indicate that the differences in shape and morphology among the three polymorphs indeed play an important role in rheological modifications.

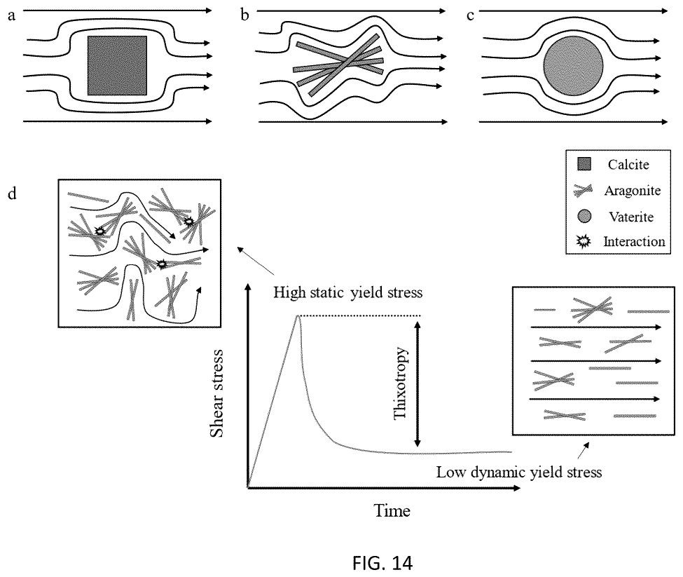

The solid volume fraction among the pastes prepared with the three polymorphs were quite similar as the specific gravity measured for the polymorphs were very closed to each other (Table 2). The needle-like shape of aragonite can form a three-dimensional network, which can significantly enhance the yield stress and viscosity of the suspension. Moreover, as the aragonite needles tend to grow as clusters, instead of a single crystal, the irregular shapes of such clusters can cause the deflection of the flow lines of the solvent flowing around them, and such effect is much stronger than for cubic calcite or spherical vaterite with similar sizes, as illustrated in FIG. 14 (a)-(c).

On the other hand, as indicated by the thixotropy index in FIG. 11, the influence of aragonite on static yield stress was much greater than that on dynamic yield stress. This can be attributed to the unique needle-like shape of the aragonite crystals, the orientation of which plays an important role in the rheological properties of the resulting suspensions. As illustrated in FIG. 14 (d), at the initial mixing stage, the large specific surface area of the aragonite crystals increases the probability of particle-particle interactions, leading to a formation of a three-dimensional network. The needle-like aragonite crystals can act as bridges between cement grains and hydration products, further increasing the physical interactions and interlocking of the particles, which lead to a high static yield stress. After the flow of the suspension initiates, the high aspect ratio of aragonite crystals allows them to adapt their orientation to the shear direction, causing a relatively low dynamic yield stress. This may explain why aragonite-containing suspensions had a high thixotropy index compared to the rest of the specimens. Without being bound to any particular theory or embodiment, the yield stress and viscosity within a suspension can originate from the friction and interaction between particles. Aragonite can increase particle friction and interaction significantly due to its high surface area and high aspect ratios from its needle-like morphology.

Finally, when comparing the cement-water systems with the cement-kerosene systems, the static yield stress of Aragonite20 in the water systems is ˜6 times higher than that of Calcite20 and Vaterite20, while it is only ˜2 times higher in the kerosene systems. This indicates that apart from this pure geometry effect, there may be other factors that contribute to the increase in yield stress in Aragonite20 as well, as discussed in the following sections.

### Hydration Kinetics

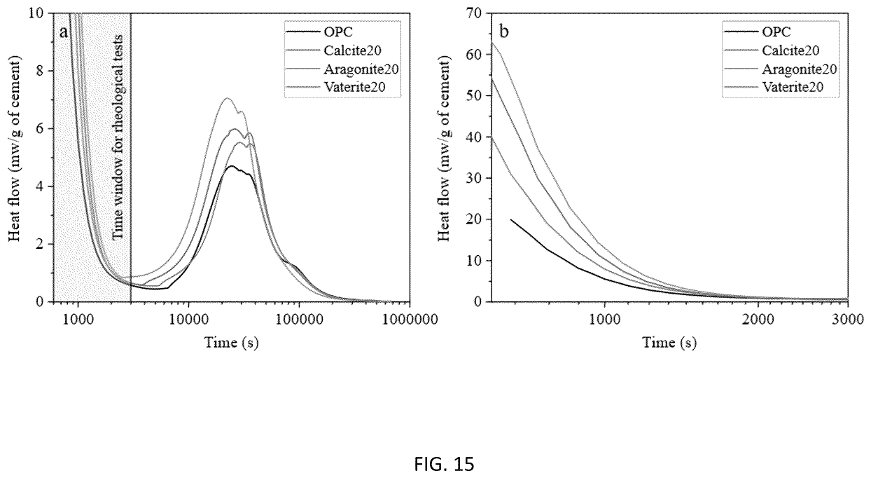

The heat flow of cement pastes with 20 wt. % calcium carbonate polymorph replacement are shown in FIG. 15 (a), and a rescaled plot showing only the heat flow during the time window of the rheological tests is shown in FIG. 15 (b). Heat flow is plotted as per gram of cement to identify any accelerating effects the polymorphs may have on cement hydration. The replacement of cement with calcium carbonate polymorphs accelerated the hydration of cement due to the filler effect within 18-24 hours.

The presence of calcium carbonate polymorphs provided additional surface area to act as nucleation sites for the growth of cement hydrated phases. Aragonite had the strongest accelerating effect, followed by calcite and vaterite. The different accelerating effects of calcium carbonate polymorphs are most likely due to the differences in the specific surface area of these materials.

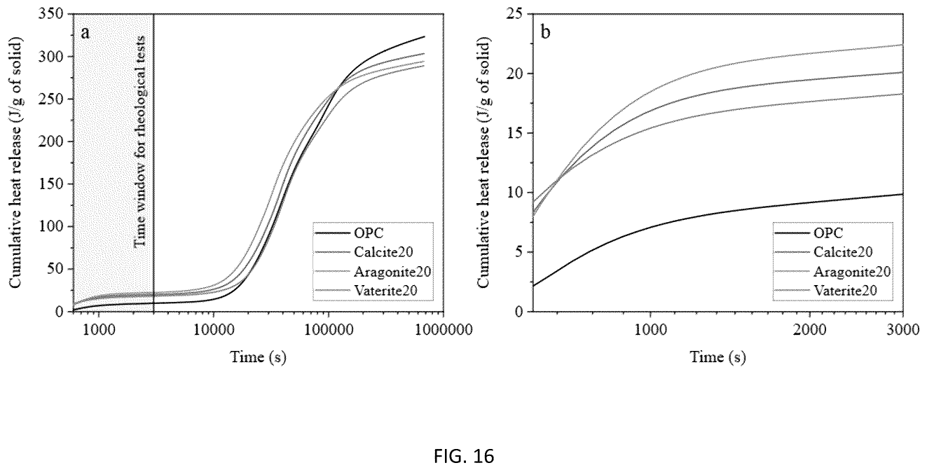

Due to the morphology of aragonite, it has the highest surface area (FIG. 4), which can provide the largest surface area for the nucleation and growth of cement hydrated phases. These different rates can affect the total heat releases of the mixtures, which are plotted as per gram of solid, as shown in FIG. 16.

Normalization based on per gram of solid can show the absolute heat release of the specimens, which is typically a good indicator of the mechanical properties of cement paste as more heat release represents the formation of more hydrated phases and therefore denser microstructure. In the fresh state, it also indicates additional solid volume produced in the suspension, which can have a significant impact on the rheological properties, as discussed in the preceding sections. It can be seen that although the cumulative heat release of cement pastes with calcium carbonate after ˜24 hours were all surpassed by that of the OPC (FIG. 16 (a)), at the early ages, especially during the time window of rheological tests (FIG. 16 (b)), the heat releases of the calcium carbonate-containing specimens were much higher than that of OPC. Without being bound to any particular theory or embodiment, this implies that they had higher volumes of solid hydrated phase formation, which will directly affect their rheological properties.

When comparing OPC with Calcite20 and Vaterite20, although Calcite20 and Vaterite20 have less cement (80 wt. %), which means that less additional solid hydrated phases are produced over time, the yield stress, both static (FIG. 9) and dynamic (FIG. 10), and storage modulus (FIG. 12) of these two specimens did not decrease. Without being bound to any particular theory, this implies that the accelerating effect of calcite and vaterite can compensate for the dilution effect due to the lower cement content, which enables Calcite20 and Vaterite20 to have a solid content similar to OPC, thus presenting comparable yield stress. For Aragonite20, its highest accelerating effect means that it has more solid volume than Calcite20 and Vaterite20, and the influence of this additional solid volume on rheology may even be amplified by the fact that the hydrated phases grown on the surface of aragonite may further increase its irregularity. This caused an increase in structural build-up rate as evidenced by static yield stress development and storage modulus evolution. Therefore, hydration effect may also partly contribute to the increase in yield stress in aragonite-containing specimens.

### Surface Charge

The surface charge of the calcium carbonate polymorphs may affect their interactions with other colloids present in the suspensions including unhydrated cement clinkers and cement hydrated phases. The magnitude of zeta potential indicates the stability of colloids when dispersed into a liquid. Higher absolute values of zeta potential represent higher degree of electrostatic repulsion between adjunct and similarly charged particles and therefore better stability, as shown in Table 6.

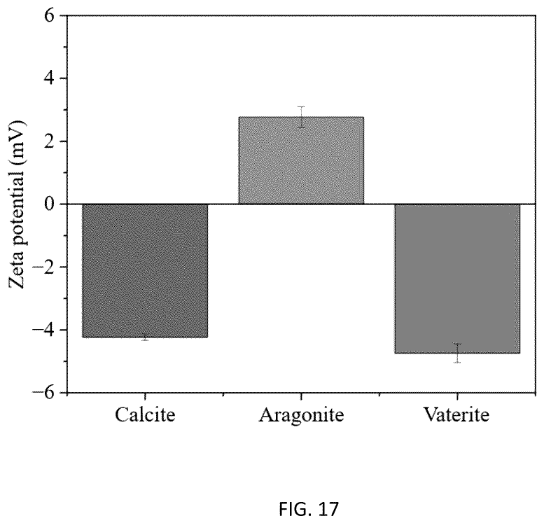

FIG. 17 shows the zeta potential of these polymorphs dispersed in deionized water (pH=7). The zeta potential measured for these polymorphs all fell into the magnitude of 0 to ±5, indicating poor stability when dispersed into water and can rapidly coagulate. On the other hand, it is interesting to note that aragonite seemed to have positive charge, different from calcite and vaterite, which both possessed negative charge. The differences in such charging behavior may affect how they attract ions in the cement pore solutions and interact with the cement clinkers and hydrated phases in the cement paste systems, as different cement phases may have different surface charging; for example, ettringite and monosulfate have positive charge while portlandite have negative charge.

TABLE 6
Stability behavior of a colloid depending on zeta potential

| Magnitude of zeta potential (mV) | Stability behavior |
|---|---|
| 0 to ±5 | Rapid coagulation or flocculation |
| ±10 to ±30 | Incipient instability |
| ±30 to ±40 | Moderate stability |
| ±40 to ±60 | Good stability |
| >±61 | Excellent stability |

### SUMMARY

Three anhydrous polymorphs of calcium carbonate were synthesized at laboratory conditions in this study. Various analytical techniques including SEM, LD, BET, XRD and TGA were used to characterize the synthetic polymorphs. These polymorphs were then used as cement substitutions to partially replace cement. Their influence on the rheology of cement pastes were investigated and underlying mechanisms were discussed with additional experimental support. Based on the experimental results, the following conclusions can be drawn from this research:

Calcite and vaterite did not significantly change the viscosity and yield stress of the cement pastes, while aragonite had a much stronger effect. The increase in static yield stress by aragonite is much higher than the increase in dynamic yield stress or dynamic viscosity, which can be attributed to the unique behavior of needle-like aragonite crystals during shearing.

The initial structure of cement pastes with aragonite had higher static yield stress and storage modulus. A faster structural build-up rate was also indicated by static yield stress development and storage modulus evolution, which can be due to the strong accelerating effect aragonite has on cement hydration.

The three synthetic calcium carbonate polymorphs presented different degrees of accelerating effects on cement hydration. Aragonite had the strongest accelerating effects, followed by calcite and vaterite. The differences may have resulted from the various specific surface areas of the polymorphs.

The mechanisms regarding the increase in rheological properties due to the incorporation of aragonite are threefold and may be decomposed into geometric features, hydration kinetics and surface charge. Geometry effect plays a key role in modifying the rheology, while hydration behavior also contributes to some extent. The surface charge seemed not to contribute significantly, but further research is required to understand how it affects the interactions between aragonite and other cement phases. Aragonite can thus be used to replace traditional limestone powder, i.e. calcite, for select applications, as aragonite can increase the static yield stress with minimal effect on dynamic yield stress or viscosity. This can be useful in applications such as reducing self-consolidating formwork pressure, shotcreting, and 3D printing.

### Aspects

The following Aspects are illustrative only and do not limit the scope of the present disclosure or the appended claims. Any part or parts of any one or more Aspects can be combined with any part or parts of any one or more other Aspects.

Aspect 1. A building material, comprising: a base material and an amount of aragonite, the aragonite optionally present at up to about 60 wt % of the total weight of the base material and the aragonite. The building material can include, for example, water or other fluids as well as additives. Additives can include, for example, polymers; polymers can include rubber, mixed sand aggregates, carbon-sulfur polymers, and geopolymers. A polymer can be present to provide crack repair and resistance, as but some examples. The building material can also include aggregate.

The building material can be present as a paste, slurry, or in other form. A building material according to the present disclosure can be dispensed, for example by extrusion, by gravity, or otherwise. A building material according to the present disclosure can be used in a variety of techniques, for example horizontal and vertical slipforming, jump forming and cantilever forming, flying forms, lift slab, tunnel forming, traveling forms, tilt-up, leave-in-place forms, shotcreting, preplaced aggregate concrete, tremie concrete, slurry wall construction, and the like.

Aspect 2. The building material of Aspect 1, wherein the aragonite is present at from about 5 to about 60 wt % of the total weight of the base material and the aragonite. The aragonite can be present at from, for example, from about 5 to about 60 wt % of the total weight of the base material and the aragonite, or from about 10 to about 50 wt % of the total weight of the base material and the aragonite, or from about 15 to about 45 wt % of the total weight of the base material and the aragonite, or from about 20 to about 40 wt % of the total weight of the base material and the aragonite, or from about 25 to about 35 wt % of the total weight of the base material and the aragonite.

Aspect 3. The building material of Aspect 2, wherein the aragonite is present at from about 5 to about 20 wt % of the total weight of the base material and the aragonite.

Aspect 4. The building material of Aspect 3, wherein the aragonite is present at from about 5 to about 10 wt % of the total weight of the base material and the aragonite.

Aspect 5. The building material of any one of Aspects 1-4, wherein the base material comprises any one or more of a cementitious material, a clay, a biopolymer, gypsum, and lime. Without being bound to any particular theory or embodiment, cementitious base materials are considered particularly suitable.

Cementitious materials can include, for example, any one or more of Portland cement, calcium sulfoaluminate cement, calcium aluminate cement, and calcium carbonate cement (vaterite). Example, non-limiting biopolymers include sodium alginate, locust bean gum, guar gum, xanthan gum, as but some examples.

As described elsewhere herein, aragonite can be present at from about 5 to about 60 wt % of the total weight of the base material and the aragonite. The aragonite can be present at from, for example, from about 5 to about 60 wt % of the total weight of the base material and the aragonite, or from about 10 to about 50 wt % of the total weight of the base material and the aragonite, or from about 15 to about 45 wt % of the total weight of the base material and the aragonite, or from about 20 to about 40 wt % of the total weight of the base material and the aragonite, or from about 25 to about 35 wt % of the total weight of the base material and the aragonite.

One can form a building material as described herein by mixing the base material-which can be, for example, any one or more of a cementitious material, a clay, a biopolymer, gypsum, and lime—and the aragonite. Other fluid—such as water—can be present, and the net result can be a building material that is a paste. The mixing can be accomplished manually, but the mixing can also be accomplished in a mechanical fashion.

Aspect 6. The building material of Aspect 5, wherein the base material comprises a cementitious material. Hydraulic cements are considered particularly suitable, but are not a requirement.

Aspect 7. The building material of Aspect 6, wherein the cementitious material is a hydraulic cement, the hydraulic cement optionally being a Portland cement.

Aspect 8. The building material of any one of Aspects 6-7, wherein the building material exhibits a dynamic viscosity of from about 1.25 to about 2.35 Pa·s.

Aspect 9. The building material of any one of Aspects 6-7, wherein the building material exhibits a starting static yield stress of from about 88.3 to about 645.2 Pa. A starting static yield stress can be, for example, from about 90 to about 640 Pa, from about 120 to about 610 Pa, from about 120 to about 575 Pa, from about 150 to about 540 Pa, from about 190 to about 490 Pa, from about 230 to about 450 Pa from about 250 to about 400 Pa, or even from about 275 to about 350 Pa.

Aspect 10. The building material of any one of Aspects 6-7, wherein the building material exhibits a static yield stress development rate of from about 0.098 to about 0.676 Pa/s. A static yield stress development rate can be, for example from about 0.1 to about 0.65 Pa/s, from about 0.2 to about 0.5 Pa/s, from about 0.3 to about 0.4 Pa/s, or even about 0.35 Pa/s.

Aspect 11. The building material of any one of Aspects 6-7, wherein the building material exhibits a dynamic yield stress of from about 31.6 to about 81.8 Pa. A dynamic yield stress can be, for example, from about 31.5 to about 81 Pa, or from about 35 to about 75 Pa, or from about 40 to about 70 Pa, or from about 45 to about 60 Pa, or even from about 50 to about 55 Pa.

Aspect 12. The building material of any one of Aspects 6-7, wherein the building material exhibits a dynamic yield stress development rate of from about 0.0014 to about 0.0238 Pa/s. A dynamic yield stress development rate can be, for example, from about 0.0015 to about 0.23 Pa/s, or from about 0.002 to about 0.2 Pa/s, or from about 0.005 to about 0.15 Pa/s, or from about 0.01 to about 0.1 Pa/s, or from about 0.015 to about 0.08 Pa/s, or from about 0.03 to about 0.07 Pa/s, or even from about 0.04 to about 0.06 Pa/s.

Aspect 13. The building material of any one of Aspects 6-7, wherein the building material exhibits at least one of (i) an amplitude of flocculation/C-S-H network recovery from about 91694 to about 171030 Pa and (ii) a rate of structural buildup from hydration of from about 39.4 to about 51.3 Pa/s. An amplitude of flocculation/C-S-H network recovery can be from about 91694 to about 171030 Pa, or from about 95000 to about 165000 Pa, or from about 105000 to about 150000 Pa, or from about 115000 to about 145000 Pa, or from about 125000 to about 130000 Pa. A rate of structural buildup from hydration can be, for example from about 39.5 to about 51 Pa/s, or from about 41 to about 48 Pa/s, or from about 42 to about 47 Pa/s, or even from about 43 to about 45 Pa/s.

Aspect 14. The building material of any one of Aspects 1-13, wherein the building material exhibits a thixotropic index from about 2.8 to about 8.0, for example from about 2.8 to about 8.0, from about 3 to about 7.8, from about 3.3 to about 7.3, from about 3.7 to about 7.0, from about 4 to about 6.7, from about 4.3 to about 6.4, from about 4.7 to about 6, or even from about 5 to about 5.5.

Aspect 15. The building material of Aspect 5, wherein the base material comprises a clay. Such materials can include clay-derived materials, such as brick. A base material can also, for example, include a ceramic.

Aspect 16. The building material of Aspect 5, wherein the base material comprises a biopolymer. Example, non-limiting biopolymers include any one or more of sodium alginate, locust bean gum, guar gum, and xanthan gum.

Aspect 17. The building material of Aspect 5, wherein the base material comprises gypsum.

Aspect 18. The building material of Aspect 5, wherein the base material comprises lime.

Aspect 19. A structural concrete, the structural concrete comprising an amount of a building material according to any one of Aspects 1-14, wherein the base material comprises a cementitious material. Example cementitious materials are described elsewhere herein.

Aspect 20. A method, comprising combining a base material and an amount of aragonite so as to give rise to a cement paste according to any one of Aspects 1-18. Example base materials and example aragonite levels are described elsewhere herein.

Aspect 21. A method, comprising dispensing an amount of a building material according to any one of Aspects 1-18 in a manufacturing process. Some such processes include, for example, horizontal and vertical slipforming, jump forming, cantilever forming, flying forms, lift slab, tunnel forming, traveling forms, tilt-up, leave-in-place forms, shotcreting, preplaced aggregate concrete, tremie concrete, and slurry wall construction.

Aspect 22. The method of Aspect 21, wherein the manufacturing process is an additive manufacturing process. Such a process can be accomplished by a 3D printer or other dispenser.

Aspect 23. The method of any one of Aspects 21-22, wherein the dispensing gives rise to at least a portion of a structure. Structures can be, for example, parts of residential and/or commercial buildings. Structures can also comprise a structural element; such elements can be any one or more of a shell, a beam, a foundation, a floor, and a wall.

Aspect 24. The method of Aspect 23, wherein the structure is a commercial or residential building.

Aspect 25. A structure, comprising: a structural element comprising a building material, the building material comprising a base material and an amount of aragonite, the aragonite optionally present at up to about 60 wt % of the total weight of the base material and the aragonite.

Aspect 26. The structure of Aspect 25, wherein the element has a flexural strength greater than the flexural strength of a comparable element free of aragonite.

Aspect 27. The structure of Aspect 26, wherein the element has a flexural strength of up to about 12% greater than the flexural strength of the comparable element free of aragonite.

Aspect 28. The structure of Aspect 27, wherein the element has a flexural strength of up to about 10% greater than the flexural strength of the comparable element free of aragonite.

Aspect 29. The structure of Aspect 28, wherein the element has a flexural strength of up to about 8% greater than the flexural strength of the comparable element free of aragonite.

Aspect 30. The structure of Aspect 29, wherein the element has a flexural strength of up to about 5% greater than the flexural strength of the comparable element free of aragonite.

Aspect 31. The structure of any one of Aspects 25-30, wherein the aragonite is present at up to about 60 wt % of the total weight of the base material and the aragonite. The aragonite can be present at from, for example, from about 5 to about 60 wt % of the total weight of the base material and the aragonite, or from about 10 to about 50 wt % of the total weight of the base material and the aragonite, or from about 15 to about 45 wt % of the total weight of the base material and the aragonite, or from about 20 to about 40 wt % of the total weight of the base material and the aragonite, or from about 25 to about 35 wt % of the total weight of the base material and the aragonite.

Aspect 32. The structure of Aspect 31, wherein the aragonite is present at from about 5 to about 60 wt % of the total weight of the base material and the aragonite.

Aspect 33. The structure of Aspect 32, wherein the aragonite is present at from about 5 to about 20 wt % of the total weight of the base material and the aragonite.

Aspect 34. The structure of Aspect 33, wherein the aragonite is present at from about 5 to about 10 wt % of the total weight of the base material and the aragonite.

Aspect 35. The structure of any one of Aspects 25-34, wherein the base material comprises any one or more of a cementitious material, a clay, a biopolymer, gypsum, and lime. Examples of the foregoing are provided elsewhere herein; for example, a biopolymer can include any one or more of sodium alginate, locust bean gum, guar gum, and xanthan gum.

Aspect 36. The structure of Aspect 35, wherein the base material comprises a cementitious material.

Aspect 37. The structure of Aspect 36, wherein the cementitious material is a hydraulic cement, the hydraulic cement optionally being a Portland cement.

Aspect 38. The structure of any one of Aspects 25-37, wherein the structural element comprises any one or more of a shell, a beam, a foundation, a floor, and a wall.

Aspect 39. The structure of any one of Aspects 25-38, wherein the structural element comprises a plurality of layers.

Aspect 40. The structure of any one of Aspects 25-39, wherein the structural element comprises a cantilevered portion.

Without being bound to any particular theory or embodiment, one can assay a structure for the presence of aragonite using X-ray diffraction; X-ray diffraction can also be coupled with Rietveld analysis to determine the weight percentage of aragonite in a sample under analysis. Fourier-transform infrared spectroscopy (FTIR) is another technique to detect aragonite presence.

One can also determine the assay for presence of aragonite optically. Without being bound by any particular theory or embodiment, an aragonite-containing structure can be whiter in color than a comparable structure that is free of aragonite.

### REFERENCES

ADDIN Mendeley Bibliography CSL_BIBLIOGRAPHY [1] B. Lothenbach, G. Le Saout, E. Gallucci, K. Scrivener, Influence of limestone on the hydration of Portland cements, Cem. Concr. Res. 38 (2008) 848-860. https://doi.org/10.1016/j.cemconres.2008.01.002.
[2] D. P. Bentz, Modeling the influence of limestone filler on cement hydration using CEMHYD3D, Cem. Concr. Compos. 28 (2006) 124-129. https://doi.org/10.1016/j.cemconcomp.2005.10.006.
[3] H. Nebel, M. Epple, Continuous preparation of calcite, aragonite and vaterite, and of magnesium-substituted amorphous calcium carbonate (Mg-ACC), Zeitschrift Fur Anorg. Und Allg. Chemie. 634 (2008) 1439-1443. https://doi.org/10.1002/zaac.200800134.
[4] R. B. Greegor, N. E. Pingitore, F. W. Lytle, Strontianite in coral skeletal aragonite, Science (80-.). 275 (1997) 1452-1454. https://doi.org/10.1126/science.275.5305.1452.
[5] J. Chen, L. Xiang, Controllable synthesis of calcium carbonate polymorphs at different temperatures, Powder Technol. 189 (2009) 64-69. https://doi.org/10.1016/j.powtec.2008.06.004
[6] Y. Dai, H. Zou, H. Zhu, X. Zhou, Y. Song, Z. Shi, Y. Sheng, Controlled synthesis of calcite/vaterite/aragonite and their applications as red phosphors doped with Eu3+ ions, CrystEngComm. 19 (2017) 2758-2767. https://doi.org/10.1039/c7ce00375g.
[7] Y. Ding, Y. Liu, Y. Ren, H. Yan, M. Wang, D. Wang, X. Y. Lu, B. Wang, T. Fan, H. Guo, Controllable synthesis of all the anhydrous CaCO₃ polymorphs with various morphologies in CaCl₂)—NH₃—CO₂ aqueous system, Powder Technol. 333 (2018) 410-420. https://doi.org/10.1016/j.powtec.2018.04.056.
[8] K. Sawada, The mechanisms of crystallization and transformation of calcium carbonates, Pure Appl. Chem. 69 (1997) 921-928. https://doi.org/10.1351/pac199769050921.
[9] R. Chang, D. Choi, M. H. Kim, Y. Park, Tuning crystal polymorphisms and structural investigation of precipitated calcium carbonates for CO₂ mineralization, ACS Sustain. Chem. Eng. 5 (2017) 1659-1667. https://doi.org/10.1021/acssuschemeng.6b02411.
[10] O. A. Jimoh, K. S. Ariffin, H. Bin Hussin, A. E. Temitope, Synthesis of precipitated calcium carbonate: a review, Carbonates and Evaporites. 33 (2018) 331-346. https://doi.org/10.1007/s13146-017-0341-x.
[11] S. Tadier, S. Rokidi, C. Rey, C. Combes, P. G. Koutsoukos, Crystal growth of aragonite in the presence of phosphate, J. Cryst. Growth. 458 (2017) 44-52. https://doi.org/10.1016/j.jcrysgro.2016.10.046.
[12] G. Rim, N. Roy, D. Zhao, S. Kawashima, P. Stallworth, S. G. Greenbaum, A. H. A. Park, CO₂ utilization in built environment via the PCO₂ swing carbonation of alkaline solid wastes with different mineralogy, Faraday Discuss. 230 (2021) 187-212. https://doi.org/10.1039/d1fd00022e.
[13] N. Zhang, A. Moment, Upcycling Construction and Demolition Waste into Calcium Carbonates: Characterization of Leaching Kinetics and Carbon Mineralization Conditions, ACS Sustain. Chem. &amp; Eng. 11 (2023) 866-879. https://doi.org/10.1021/acssuschemeng.2c04241.
[14] K. L. Scrivener, Options for the future of cement, Indian Concr. J. 88 (2014) 11-21.
[15] E. Gartner, Industrially interesting approaches to “low-CO₂” cements, Cem. Concr. Res. 34 (2004) 1489-1498. https://doi.org/10.1016/j.cemconres.2004.01.021.
[16] D. Zhao, R. Khoshnazar, Microstructure of cement paste incorporating high volume of low-grade metakaolin, Cem. Concr. Compos. 106 (2020). https://doi.org/10.1016/j.cemconcomp.2019.103453.
[17] D. Zhao, R. Khoshnazar, Hydration and microstructural development of calcined clay cement paste in the presence of calcium-silicate-hydrate (C-S-H) seed, Cem. Concr. Compos. 122 (2021). https://doi.org/10.1016/j.cemconcomp.2021.104162.
[18] Y. Tian, N. J. Themelis, D. Zhao, A. C. Thanos Bourtsalas, S. Kawashima, Stabilization of Waste-to-Energy (WTE) fly ash for disposal in landfills or use as cement substitute, Waste Manag. 150 (2022) 227-243. https://doi.org/10.1016/J.WASMAN.2022.06.043.
[19] K. Scrivener, F. Martirena, S. Bishnoi, S. Maity, Calcined clay limestone cements (LC3), Cem. Concr. Res. 114 (2018) 49-56. https://doi.org/10.1016/j.cemconres.2017.08.017.
[20] F. Zunino, F. Martirena, K. Scrivener, Limestone calcined clay cements (LC₃), ACI Mater. J. 118 (2021) 49-60. https://doi.org/10.14359/51730422.
[21] K. De Weerdt, K. O. Kjellsen, E. Sellevold, H. Justnes, Synergy between fly ash and limestone powder in ternary cements, Cem. Concr. Compos. 33 (2011) 30-38. https://doi.org/10.1016/j.cemconcomp.2010.09.006.
[22] K. De Weerdt, M. Ben Haha, G. Le Saout, K. O. Kjellsen, H. Justnes, B. Lothenbach, Hydration mechanisms of ternary Portland cements containing limestone powder and fly ash, Cem. Concr. Res. 41 (2011) 279-291. https://doi.org/10.1016/j.cemconres.2010.11.014.
[23] D. P. Bentz, Activation energies of high-volume fly ash ternary blends: Hydration and setting, Cem. Concr. Compos. 53 (2014) 214-223. https://doi.org/10.1016/j.cemconcomp.2014.06.018.
[24] D. P. Bentz, T. Sato, I. De La Varga, W. J. Weiss, Fine limestone additions to regulate setting in high volume fly ash mixtures, Cem. Concr. Compos. 34 (2012) 11-17. https://doi.org/10.1016/j.cemconcomp.2011.09.004.
[25] D. Jiao, C. Shi, Q. Yuan, X. An, Y. Liu, H. Li, Effect of constituents on rheological properties of fresh concrete-A review, Cem. Concr. Compos. 83 (2017) 146-159. https://doi.org/10.1016/j.cemconcomp.2017.07.016.
[26] K. Vance, A. Arora, G. Sant, N. Neithalath, Rheological evaluations of interground and blended cement-limestone suspensions, Constr. Build. Mater. 79 (2015) 65-72. https://doi.org/10.1016/j.conbuildmat.2014.12.054.
[27] M. Cao, X. Ming, K. He, L. Li, S. Shen, Effect of macro-, micro- and nano-calcium carbonate on properties of cementitious composites-A review, Materials (Basel). 12 (2019). https://doi.org/10.3390/ma12050781.
[28] D. K. Panesar, R. Zhang, Performance comparison of cement replacing materials in concrete: Limestone fillers and supplementary cementing materials-A review, Constr. Build. Mater. 251 (2020). https://doi.org/10.1016/j.conbuildmat.2020.118866.
[29] M. Cao, C. Zhang, J. Wei, Microscopic reinforcement for cement based composite materials, Constr. Build. Mater. 40 (2013) 14-25. https://doi.org/10.1016/j.conbuildmat.2012.10.012.
[30] M. Cao, C. Zhang, H. Lv, L. Xu, Characterization of mechanical behavior and mechanism of calcium carbonate whisker-reinforced cement mortar, Constr. Build. Mater. 66 (2014) 89-97. https://doi.org/10.1016/j.conbuildmat.2014.05.059.
[31] M. Cao, L. Xu, C. Zhang, Rheology, fiber distribution and mechanical properties of calcium carbonate (CaCO₃) whisker reinforced cement mortar, Compos. Part A Appl. Sci. Manuf. 90 (2016) 662-669. https://doi.org/10.1016/j.compositesa.2016.08.033.
[32] C. Combes, S. Tadier, H. Galliard, S. Girod-Fullana, C. Charvillat, C. Rey, R. Auzély-Velty, N. El Kissi, Rheological properties of calcium carbonate self-setting injectable paste, Acta Biomater. 6 (2010) 920-927. https://doi.org/10.1016/j.actbio.2009.08.032.
[33] R. Chang, S. Kim, S. Lee, S. Choi, M. Kim, Y. Park, Calcium carbonate precipitation for CO₂ storage and utilization: A review of the carbonate crystallization and polymorphism, Front. Energy Res. 5 (2017). https://doi.org/10.3389/fenrg.2017.00017.
[34] F. Liendo, M. Arduino, F. A. Deorsola, S. Bensaid, Factors controlling and influencing polymorphism, morphology and size of calcium carbonate synthesized through the carbonation route: A review, Powder Technol. 398 (2022). https://doi.org/10.1016/j.powtec.2021.117050.
[35] T. Ogino, T. Suzuki, K. Sawada, The formation and transformation mechanism of calcium carbonate in water, Geochim. Cosmochim. Acta. 51 (1987) 2757-2767. https://doi.org/10.1016/0016-7037 (87) 90155-4.
[36] Q. Hu, J. Zhang, H. Teng, U. Becker, Growth process and crystallographic properties of ammonia-induced vaterite, Am. Mineral. 97 (2012) 1437-1445. https://doi.org/10.2138/am.2012.3983.
[37] S. Ma, Y. Qian, S. Kawashima, Experimental and modeling study on the non-linear structural build-up of fresh cement pastes incorporating viscosity modifying admixtures, Cem. Concr. Res. 108 (2018) 1-9. https://doi.org/10.1016/j.cemconres.2018.02.022.
[38] Y. Qian, S. Kawashima, Flow onset of fresh mortars in rheometers: Contribution of paste deflocculation and sand particle migration, Cem. Concr. Res. 90 (2016) 97-103. https://doi.org/10.1016/j.cemconres.2016.09.006.
[39] G. Ovarlez, N. Roussel, A physical model for the prediction of lateral stress exerted by self-compacting concrete on formwork, Mater. Struct. Constr. 39 (2006) 269-279. https://doi.org/10.1617/s11527-005-9052-1.
[40] Y. Qian, G. De Schutter, Enhancing thixotropy of fresh cement pastes with nanoclay in presence of polycarboxylate ether superplasticizer (PCE), Cem. Concr. Res. 111 (2018) 15-22. https://doi.org/10.1016/j.cemconres.2018.06.013.
[41] A. Kumar, C. K. Dixit, Methods for characterization of nanoparticles, in: Adv. Nanomedicine Deliv. Ther. Nucleic Acids, 2017: pp. 44-58. https://doi.org/10.1016/B978-0-08-100557-6.00003-1.
[42] J. Plank, C. Hirsch, Impact of zeta potential of early cement hydration phases on superplasticizer adsorption, Cem. Concr. Res. 37 (2007) 537-542. https://doi.org/10.1016/j.cemconres.2007.01.007.

What is claimed:

1. A building material, comprising:
a base material and an amount of aragonite,
the aragonite optionally present at up to about 60 wt % of the total weight of the base material and the aragonite.

2. The building material of claim 1, wherein the aragonite is present at from about 5 to about 60 wt % of the total weight of the base material and the aragonite, optionally wherein the aragonite is present at from about 5 to about 20 wt % of the total weight of the base material and the aragonite.

3. The building material of claim 1, wherein the base material comprises any one or more of a cementitious material, a clay, a biopolymer, gypsum, and lime.

4. The building material of claim 3, wherein the base material comprises a cementitious material.

5. The building material of claim 4, wherein the cementitious material is a hydraulic cement, the hydraulic cement optionally being a Portland cement.

6. The building material of claim 5, wherein the building material exhibits any one or more of (1) dynamic viscosity of from about 1.25 to about 2.35 Pa's, (2) a starting static yield stress of from about 88.3 to about 645.2 Pa, (3) a static yield stress development rate of from about 0.098 to about 0.676 Pa/s, (4) a dynamic yield stress of from about 31.6 to about 81.8 Pa, (5) a dynamic yield stress development rate of from about 0.0014 to about 0.0238 Pa/s, or (6) at least one of (i) an amplitude of flocculation/C-S-H network recovery from about 91694 to about 171030 Pa and (ii) a rate of structural buildup from hydration of from about 39.4 to about 51.3 Pa/s.

7. The building material of claim 1, wherein the building material exhibits a thixotropic index from about 2.8 to about 8.0.

8. The building material of claim 3, wherein the base material comprises a clay.

9. The building material of claim 3, wherein the base material comprises a biopolymer.

10. The building material of claim 3, wherein the base material comprises at least one of gypsum and lime.

11. A structural concrete, the structural concrete comprising an amount of a building material according to claim 1, wherein the base material comprises a cementitious material.

12. A method, comprising dispensing an amount of a building material according to claim 1 in a manufacturing process.

13. The method of claim 12, wherein the manufacturing process is an additive manufacturing process, optionally wherein the dispensing gives rise to at least a portion of a structure.

14. A structure, comprising:
a structural element comprising a building material,
the building material comprising a base material and an amount of aragonite,
the aragonite optionally present at up to about 60 wt % of the total weight of the base material and the aragonite.

15. The structure of claim 14, wherein the element has a flexural strength greater than the flexural strength of a comparable element free of aragonite, the element optionally having a flexural strength of up to about 12% greater than the flexural strength of the comparable element free of aragonite.

16. The structure of claim 14, wherein the base material comprises any one or more of a cementitious material, a clay, a biopolymer, gypsum, and lime.

17. The structure of claim 16, wherein the base material comprises a cementitious material, the cementitious material optionally being a hydraulic cement.

18. The structure of claim 14, wherein the structural element comprises any one or more of a shell, a beam, a foundation, a floor, and a wall.

19. The structure of claim 14, wherein the structural element comprises a plurality of layers.

20. The structure of claim 14, wherein the structural element comprises a cantilevered portion.
